(19) United States
(12) Patent Application Publication
(10) Pub. No.: US 2014/0160439 A1
(43) Pub. Date: Jun. 12, 2014

(54) IMAGE DISPLAY DEVICE

(71) Applicant: Funai Electric Co., Ltd., Osaka (JP)

(72) Inventors: Atsushi IKEDA, Osaka (JP); Atsuya HIRANO, Osaka (JP)

(73) Assignee: Funai Electric Co., Ltd., Osaka (JP)

(21) Appl. No.: 14/093,731

(22) Filed: Dec. 2, 2013

(30) Foreign Application Priority Data
Dec. 10, 2012 (JP) 2012-269149
Dec. 11, 2012 (JP) 2012-269888

(51) Int. Cl. G03B 21/16; G03B 21/20

(52) U.S. Cl. CPC G03B 21/16; G03B 21/2033
USPC 353/31

(57) ABSTRACT

An image display device has a housing, a plurality of support members, and a plurality of light source elements. The support members are attached to the housing. The light source elements are attached to the housing via the support members, respectively. The support members are dimensioned such that the support members have surface areas according to heat generation properties of the light source elements, respectively.

### CROSS-REFERENCE TO RELATED APPLICATIONS

This application claims priority to Japanese Patent Application Nos. 2012-269149 filed on Dec. 10, 2012 and 2012-269888 filed on Dec. 11, 2012. The entire disclosures of Japanese Patent Application Nos. 2012-269149 and 2012-269888 are hereby incorporated herein by reference.

### BACKGROUND

1. Field of the Invention

The present invention generally relates to an image display device. More specifically, the present invention relates to an image display device in which a plurality of light source elements are attached to a housing.

2. Background Information

Laser light source devices are utilized as the light source for a variety of devices, and there is a known laser light source device in which laser light source elements for a red component (R), a green component (G), and a blue component (B) are attached to a housing in order to obtain a color light source, for example.

A light source device such as this, as typified by a laser projector, for example, has been used as a light source in various kinds of image display device that display images on a projection surface by scanning with color laser light and projecting the color laser light onto the projection surface.

A conventional projector is known with which the deterioration of image quality caused by offset of the optical axis of the projector due to heat generation is prevented when the amount of light is raised to brighten the screen, and the cooling system is made more compact so that there is no loss of portability (see Japanese Laid-Open Patent Application Publication No. 2010-107751, for example). To this end, after the position and angle of the laser diodes and optical elements have been adjusted so that the optical axis of light from the various light sources will fall along the same axis, and these components have been fixed to the housing, the heat generated during the operation of the laser diodes can cause the temperature of the housing to rise and cause offset in the aligned optical axes due to distortion of the housing. To prevent this, a cooling structure floating in a small air gap away from the housing is fixed to the housing with a heat transfer structure serving as a supporting beam, and the temperature of the cooling structure is lowered below the housing temperature so as to draw the heat generated from the light source, which is a heat generation source fixed to the outer peripheral wall of the housing, into the cooling structure and thereby reduce the amount of heat flowing into the housing.

Furthermore, a conventional light source device and projector is known with which the contact surface area can be increased between a heat sink and a plurality of semiconductor light emitting element main bodies, and the plurality of semiconductor light emitting elements can be cooled more efficiently (see Japanese Laid-Open Patent Application Publication No. 2012-9760, for example). To this end, the light source device comprises an excitation light source that is a plurality of semiconductor light emitting elements, a light source support that is a support member for supporting the peripheral edge of the excitation light source, a substrate that is electrically connected to lead terminals of the plurality of excitation light sources, and a heat sink that comes into contact with the main bodies of the excitation light sources. The excitation light sources are each equipped with a plurality of lead terminals extending perpendicular to a bottom component, and the substrate is disposed perpendicular to the bottom component of the excitation light sources so that the face of the substrate will come into contact with at least two of the plurality of lead terminals.

### SUMMARY

A semiconductor laser, commonly referred to as a laser diode (LD), is used for the laser light source elements used in light source devices. However, it has been discovered that these laser light source elements generate heat as they emit light.

It has also been discovered that the amount of heat generated by these laser light source elements varies with the amount of light emission (output), the emission color, and so forth.

Furthermore, with a light source device equipped with a plurality of laser light source elements, because of the need for combined light color, etc., the output of each laser light source element is sometimes varied, which means that the amount of heat generated by each laser light source element will also vary.

Conventionally, the laser light source elements are cooled by providing a special cooling structure, or by providing a special heat sink. However, it has been discovered that these are not satisfactory measures because they drive up the cost and make the structure of the light source device more complicated.

Furthermore, it has been discovered that there is no measure that takes into account a situation in which the amount of generated heat varies among the plurality of laser light source elements.

One object of the present disclosure is to provide an image display device in which a plurality of light source elements is cooled with a simple configuration.

In view of the state of the know technology, an image display device has a housing, a plurality of support members, and a plurality of light source elements. The support members are attached to the housing. The light source elements are attached to the housing via the support members, respectively. The support members are dimensioned such that the support members have surface areas according to heat generation properties of the light source elements, respectively.

Other objects, features, aspects and advantages of the present disclosure will become apparent to those skilled in the art from the following detailed description, which, taken in conjunction with the annexed drawings, discloses selected embodiments of an image display device.

### BRIEF DESCRIPTION OF THE DRAWINGS

Referring now to the attached drawings which form a part of this original disclosure:

FIG. 1 is a block diagram of an overall configuration of an image display device in accordance with a first embodiment;

FIG. 2 is a schematic diagram of an light source device of the image display device illustrated in FIG. 1;

FIG. 3(a) is a top plan view of the light source device illustrated in FIG. 2, illustrating a layout of laser light source elements of the light source device;

FIG. 3(b) is a side elevational view of the light source device illustrated in FIG. 2, illustrating the layout of the laser light source elements;

FIGS. 4(a) to 4(d) are schematic diagrams illustrating the size of support members for the laser light source elements in the light source device;

FIG. 5 is a table illustrating specifications of the laser light source elements;

FIG. 6 is a partial cross sectional view of laser light source elements of a light source device in accordance with a second embodiment;

FIG. 7(a) is a side elevational view of the light source device in accordance with the second embodiment, illustrating a layout of the laser light source elements of the light source device;

FIG. 7(b) is a bottom plan view of the light source device, illustrating the layout of the laser light source elements; and

FIGS. 8(a) to 8(e) are schematic diagrams illustrating the orientation of the laser light source elements in the light source device.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

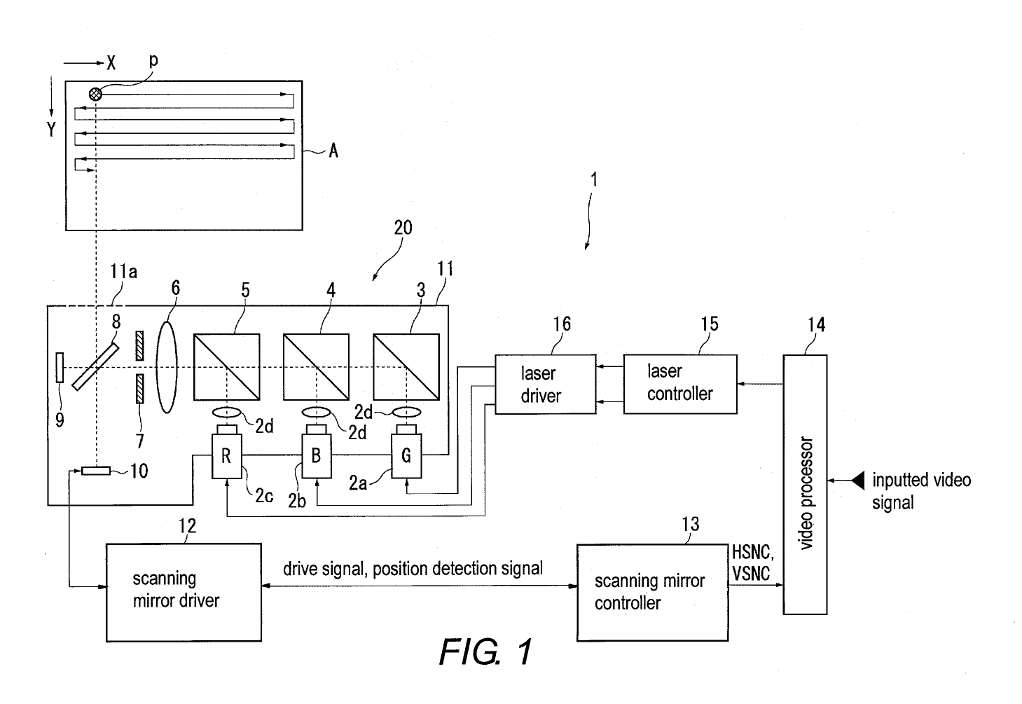

Referring initially to FIG. 1, a laser projector 1 (e.g., an image display device) is illustrated in accordance with a first embodiment. In the illustrated embodiment, the present invention is applied to the laser projector 1 with a MEMS mirror. However, of course, the present invention can be applied to a variety of image display devices.

As shown in FIG. 1, the laser projector 1 basically includes a plurality of (three in this embodiment) laser light source elements 2a to 2c (e.g., light source elements), various optical elements 3 to 8, a photodiode 9, a MEMS (Micro Electro Mechanical Systems) scanning mirror 10, and various drive and control units 12 to 16. In the illustrated embodiment, the laser projector 1 includes the laser light source elements 2a to 2c. However, when the present invention is applied to an image display device, then the image display device can include LEDs (light emission diodes) as light source elements.

The laser projector 1 combines the laser beams of the various color components (green, red, and blue) emitted by the laser light source element 2a (green component (G)), the laser light source element 2b (blue component (B)), and the laser light source element 2c (red component (R)), respectively, on the optical path produced by the optical elements 3 to 8. This combined light is reflected by the MEMS scanning mirror 10 (driven in a scanning pattern), so that a color image corresponding to the inputted video signal is displayed by scanning projection on a screen, a wall, or other such projection surface A.

The laser projector 1 further includes a light source device 20 in which the laser light source elements 2a to 2c are attached to a housing 11. The housing 11 in the illustrated embodiment holds the optical elements 3 to 8, the photodiode 9, and the MEMS scanning mirror 10. The laser beam reflected by the MEMS scanning mirror 10 goes through a window 11a provided to the housing 11, and is projected onto the projection surface A.

The laser light source elements 2a to 2c in the illustrated embodiment are laser diodes that are independently driven by drive current supplied individually from a laser driver 16.

In the illustrated embodiment, the optical elements 3 to 5 that make up the optical path are dichroic mirrors, and the dichroic mirrors 3 to 5 transmit only laser light of a particular wavelength, and reflect all others.

More specifically, green laser light emitted from the laser light source element 2a is reflected by the dichroic mirror 3, and this green laser light is combined at the dichroic mirror 4 with the blue laser light emitted from the laser light source element 2b. This combined laser light is combined at the dichroic mirror 5 with the red laser light emitted from the laser light source element 2c.

Lenses 2d that guide laser light to the dichroic mirrors 3 to 5 are provided to the laser light source elements 2a to 2c.

This combined laser light is converged by a lens 6, narrowed by an aperture 7, incident on the MEMS scanning mirror 10 via a half mirror 8, reflected by the MEMS scanning mirror 10 that is scan driven, and scan projected onto the projection surface A as discussed above.

The half mirror 8 transmits part of the incident laser light and directs it to the photodiode 9. The quantity of light detected by the photodiode 9 is inputted to a laser controller 15, and the laser controller 15 performs control so as to obtain the targeted laser output.

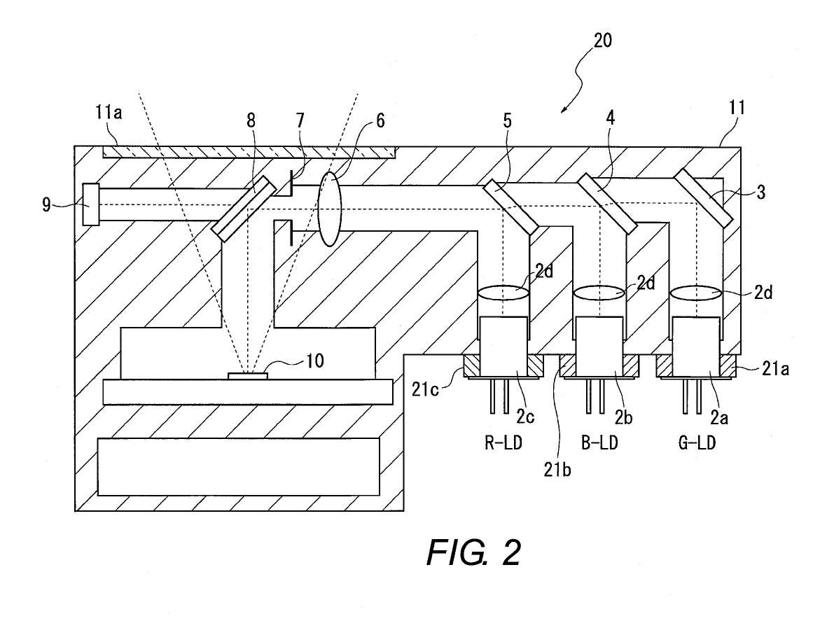

In FIG. 1, for the sake of convenience the light beam going from the lens 6, through the half mirror 8, and to the scanning mirror 10 or the photodiode 9 is shown as if it intersected the light beam going from the scanning mirror 10 to the projection surface A. However, these light beams are offset in a direction perpendicular to the viewing plane in FIG. 1 so as not to cross. The same applies to FIG. 2 (discussed below).

The scanning mirror 10 is scan driven by a scanning mirror driver 12 to which a drive signal is inputted from a scanning mirror controller 13, and the laser light that is incident on the scanning mirror 10 is reflected according to the deflection angle (deflection width) of the mirror face, and projected onto the projection surface A. This scanning mirror 10 has two-dimensional freedom corresponding to the horizontal scanning direction (X) and the vertical scanning direction (Y) of the projection surface A, and projects a color image onto the projection surface A by sequential line scanning corresponding to this two-dimensional displacement. This sequential line scanning advances a laser spot p in one direction along a horizontal scanning line on the projection surface A, then returns the laser spot p in the opposite direction along the next horizontal scanning line, and this process is continuously repeated within a single image frame.

The laser projector 1 in this embodiment performs vertical and horizontal scans of the laser beam with the scanning mirror 10 based on a video signal inputted from the outside (such as a personal computer), and projects a display of a color image on a screen A. The basic image projection processing involved here is as follows.

A video processor 14 transfers video data to the laser controller 15 at specific time intervals based on the inputted video signal (video signal and synchronization signal, etc.), which allows the laser controller 15 to obtain pixel information at a specified scanning position. With this video data transfer processing, the video processor 14 transfers video data to the laser controller 15 sequentially, according to information about the horizontal and vertical scanning positions inputted as horizontal and vertical synchronization signals (HSNC and VSNC) from the scanning mirror controller 13.

The laser controller 15 controls the laser driver 16 with a drive current waveform signal in order to project video composed of a plurality of pixels within a projection range based on pixel information about the video data.

The laser driver 16 drives the laser light source elements 2a to 2c based on the control by the laser controller 15, causing the elements to emit light.

The laser light source elements 2a to 2c output laser beams when current at or above an oscillation threshold current is supplied from the laser driver 16, and outputs more (brighter) laser light as the supplied current increases. Also, the laser light source elements 2a to 2c stop the output of laser light when the supplied current is below the oscillation threshold current.

The scanning mirror 10 is a small vibrating mirror element that is drive displaced around two perpendicular axes by the scanning mirror driver 12 and is capable of scanning displacement of its mirror face at a specific deflection angle, and can scan reflected light in the X axis direction and the Y axis direction (horizontally and vertically).

The scanning mirror controller 13 controls the scanning mirror driver 12 with a drive signal based on horizontal and vertical synchronization signals. The scanning mirror 10 undergoes scanning displacement in the horizontal and vertical directions in a zigzag pattern over the entire projection range, reflects the incident laser, and projects an image onto the screen A, based on control by the scanning mirror controller 13.

FIG. 2 shows the detailed configuration of the light source device 20 of the laser projector 1 in accordance with the first embodiment.

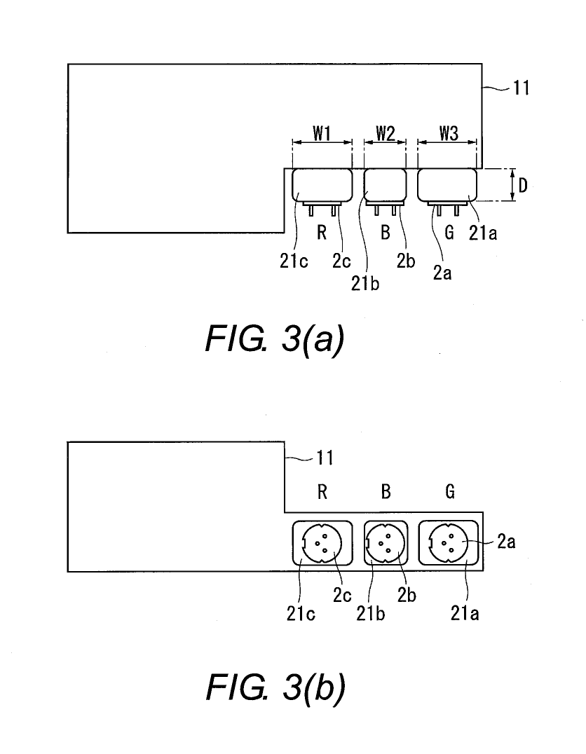

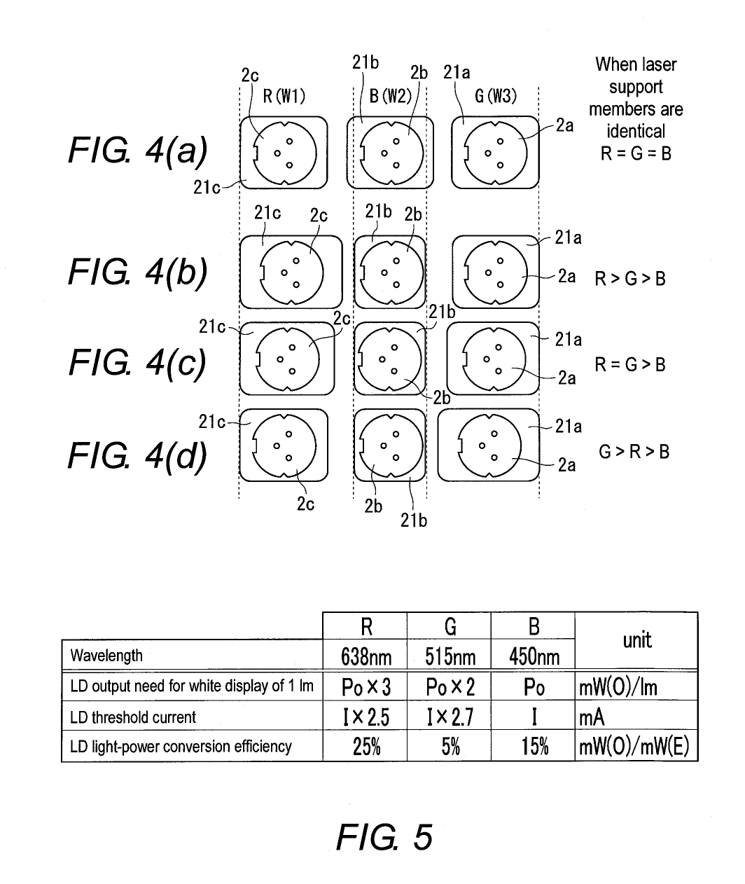

As will be discussed below through reference to FIGS. 3(a), 3(b) and 4(a) to 4(d), support members 21a to 21c to which the laser light source elements 2a to 2c are attached can have distinctive structure. However, FIG. 2 does not illustrate the distinctive structure of the support members 21a to 21c in order to illustrate the overall configuration of the light source device 20.

As shown in FIG. 2, the laser light source elements 2a to 2c are provided to the housing 11, and are attached to the housing 11 via the support members 21a to 21c, respectively.

These support members 21a to 21c are used to adjust the attachment position and orientation of the laser light source elements 2a to 2c, and to attach the laser light source elements 2a to 2c to the housing 11 at the designed position and orientation.

As discussed above, the housing 11 holds the optical elements 3 to 8, the photodiode 9, and the MEMS scanning mirror 10. Because the scanning mirror 10 is housed, for example, a portion of the housing 11 on the downstream portion of the optical path has a shape in which the volume is larger than that of the upstream portion where the laser light source elements 2a to 2c are attached. Specifically, the portion of the housing 11 on the downstream portion of the optical path has a larger surface area than the upstream portion where the laser light source elements 2a to 2c are attached. Furthermore, since the scanning mirror 10 (e.g., a movable part) is housed, and the optical path for the scanning mirror 10 is set in the portion of the housing 11 on the downstream portion of the optical path, the housing itself is formed as having a complicated or intricate structure. More specifically, in the illustrated embodiment, as shown in FIGS. 1, 2, 3(a) and 3(b), the housing 11 has a large volume portion (e.g., a first portion) and a small volume portion (e.g., a second portion) that has a smaller volume than the large volume portion. The large and small volume portions are arranged next to each other, and the optical path extends from the small volume portion to the large volume portion. As shown in FIG. 2, the laser light source elements 2a to 2c are attached to the small volume portion, while the lens 6, the aperture 7, the half mirror 8, the photodiode 9, and the scanning mirror 10 are housed in the large volume portion. The large volume portion has a larger outer surface area than the small volume portion. The large volume portion also has a larger inner surface area than the small volume portion since the inner structure of the large volume portion defined by the downstream portion of the optical path is more complex or intricate than the inner structure of the small volume portion defined by the upstream portion of the optical path. In other words, in the illustrated embodiment, the large volume portion has a more complex structure than the small volume portion. Furthermore, in the illustrated embodiment, the large volume portion has a larger heat capacity than the small volume portion. In the illustrated embodiment, since the housing 11 is integrally formed, the large volume portion has more mass than the small volume portion. In the illustrated embodiment, as shown in FIGS. 3(a) and 3(b), the laser light source elements 2a to 2c are arranged in a row on the small volume portion. The laser light source element 2c is disposed closer to the large volume portion than the laser light source elements 2a and 2b. The laser light source element 2a is disposed closer to an end portion of the small volume portion (e.g., an end portion of the housing 11) than the laser light source elements 2b and 2c. The end portion of the small volume is located away from the large volume portion.

As discussed above, the laser light source elements 2a to 2c are attached to the housing 11 via the support members 21a to 21c, so heat generated by the laser light source elements 2a to 2c is transmitted through the support members 21a to 21c to the housing 11.

Therefore, heat generated by the laser light source elements 2a to 2c is eliminated when the support members 21a to 21c absorb or release the heat themselves, or when the heat is absorbed or released by the housing 11.

The housing 11 and the support members 21a to 21c can be formed from a synthetic resin, metal, or the like, but a material with high thermal conductivity is preferable.

FIGS. 3(a) and 3(b) show the shape and layout of the support members 21a to 21c. FIG. 3(a) is a top plan view and FIG. 3(b) is a side elevational view. Specifically, in the illustrated embodiment, the support members 21a to 21c schematically shown in FIG. 2 have the shape and layout shown in FIG. 3.

The laser light source elements 2a to 2c each have different characteristics, design requirements for the laser projector 1, and so forth, and therefore the amount of heat generated by their operation also differs.

For instance, as shown in FIG. 5, if the laser light source element 2a outputs green (G) laser light with a wavelength of 515 nm, the laser light source element 2b outputs blue (B) laser light with a wavelength of 450 nm, and the laser light source element 2c outputs red (R) laser light with a wavelength of 638 nm, then the output of the laser light source elements (LD) needed for a white display of 1 lm decreases in the order of the R laser light source element 2c, the G laser light source element 2a, and the B laser light source element 2b (in order from largest to smallest), and the amount of heat generated due to this decreases in the same order.

Also, as shown in FIG. 5, for example, in the same situation, the LD threshold current decreases in the order of the G laser light source element 2a, the R laser light source element 2c, and the B laser light source element 2b, and the amount of heat generated due to this decreases in the same order.

Also, as shown in FIG. 5, for example, in the same situation, the order in which the conversion efficiency between the LD emission quantity and the power increases is the order of the G laser light source element 2a, the B laser light source element 2b, and the R laser light source element 2c (in order from smallest to largest), and the amount of heat generated due to this is in the same order.

To accommodate the fact that the amount of heat generated by the laser light source elements 2a to 2c is thus different, in the illustrated embodiment, as shown in FIGS. 3(a) and 3(b), the surface areas of the support members 21a to 21c is set according to the amount of heat generated by the laser light source elements 2a to 2c (e.g., heat generation properties) supported by the support members 21a to 21c.

In the illustrated embodiment, as shown in FIGS. 3(a) and 3(b), the amount of heat generated in total (e.g., heat generation properties) decreases in the order of the G laser light source element 2a, the R laser light source element 2c, and the B laser light source element 2b, and accordingly the surface areas of the support members decreases in the order of the support member 21a, the support member 21c, and the support member 21b. In other words, in the illustrated embodiment, the laser light source element 2a has the largest heat generation property, the laser light source element 2c has the second largest heat generation property, and the laser light source element 2b has the smallest heat generation property.

Consequently, the extent to which the heat generated by the laser light source elements 2a to 2c is absorbed or released by the support members 21a to 21c, respectively, and the extent to which heat is transmitted through the support members 21a to 21c to the housing 11 and then absorbed or released, increases in proportion to the surface areas of the support members 21a to 21c.

Therefore, the more heat a laser light source element generates, the greater the cooling effect produced by a corresponding support member and the housing 11.

A variety of methods can be employed for varying the surface area of the support members 21a to 21c. In the illustrated embodiment, as shown in FIGS. 3(a) and 3(b), all of the support members 21a to 21c have the same thickness D, while the widths W1 to W3 are made different by setting the surface areas to be different (W1>W3>W2), thereby varying the surface areas of the support members 21a to 21c. Thus having the support members 21a to 21c all be the same thickness reduces how much the support members 21a to 21c stick out from the housing 11.

In the illustrated embodiment, the support members 21a to 21c are all the same thickness D. However, the present invention is not limited to this. The surface areas of the support members can be varied by some other method, such as varying the thickness while keeping the width the same, or varying both the width and the thickness.

In the illustrated embodiment, as discussed above, the surface areas of the support members 21a to 21c are set according to the amount of heat generated by the laser light source elements 2a to 2c. However, the laser light source elements 2a to 2c can be further arranged in the housing 11 according to the amount of heat generated.

FIGS. 4(a) to 4(d) illustrate examples of the layout of the laser light source elements 2a to 2c and the surface areas of the support members 21a to 21c corresponding to the amount of heat generated. In FIGS. 4(a) to 4(d), the positional relation between the laser light source elements 2a to 2c and the housing 11 is the same as in FIGS. 1, 2, 3(a) and 3(b). Thus, the left side in the drawing is the side with the larger volume of the housing 11, and the side where the scanning mirror 10 is housed.

If the amount of heat generated by the G, B, and R laser light source elements 2a to 2c is substantially equal (R=B=G), as shown in FIG. 4(a), then the widths W1 to W3 of the support members 21a to 21c can be made equal so that their surface areas are set the same.

On the other hand, if the amount of heat generated by the laser light source elements 2a to 2c decreases in the order of R, G, and B (R>G>B), as shown in FIG. 4(b), then the thickness of the support members 21a to 21c is made the same, while the width W1 of the support member 21c is made the largest, the width W3 of the support member 21a is made the next largest, and the width W2 of the support member 21b is made the smallest, so that the surface areas of the support members 21a to 21c decreases in the order of the support member 21c, the support member 21a, and the support member 21b.

In this example shown in FIG. 4(b), the laser light source element 2c, which generates the most heat out of the laser light source elements 2a to 2c, is disposed on the side where the volume of the housing 11 is larger, which raises the efficiency of heat absorption and released by the housing 11 for this laser light source element 2c. Furthermore, in this example shown in FIG. 4(b), the laser light source element 2a, which generates the next most heat, is disposed with the other laser light source element 2b disposed between it and the laser light source element 2c that generates the most heat, so that the laser light source elements 2a and 2c that generate larger amounts of heat are separated from one another, and cooling efficiency is enhanced.

In this example, this mode in which the laser light source element 2c that generates the most heat is disposed on the side with the larger housing volume has the same meaning as a mode in which the laser light source element 2c that generates the most heat is disposed on the side of the housing 11 with the larger surface area.

Also, a mode in which the laser light source element 2c that generates the most heat is disposed on the side with the larger housing volume has the same meaning as a mode in which the laser light source element 2c that generates the most heat is disposed on the side of the housing 11 where the scanning mirror 10 is housed, or is disposed on the side where the structure of the housing 11 is more complicated, since in this example the side with the larger volume in the housing 11 is formed by housing the scanning mirror 10, or the side with the larger volume in the housing 11 is formed by housing the optical path, optical elements, or the like.

Also, if the amount of heat generated by the R and G laser light source elements 2c and 2a is substantially the same, and the amount of heat generated by the B laser light source element 2b is smaller than with these (R=G>B), as shown in FIG. 4(c), then the support members 21a to 21c are set to the same thickness, while the width W1 of the support member 21c is set to be the same as the width W3 of the support member 21a, and the width W2 of the support member 21b is set to be the smallest, so that the surface area is the same for the support members 21c and 21a, but is smaller for the support member 21b.

In this example shown in FIG. 4(c), the laser light source element that generates the most heat out of the laser light source elements 2a to 2c (2c in this example) is disposed on the side where the volume of the housing 11 is larger, which enhances the efficiency of heat absorption and release by the housing 11 for that laser light source element 2c. Similarly, the laser light source element that generates the most heat (2a in this example) is disposed at the end of the housing 11, which enhances the efficiency of heat dissipation by the housing 11 for this laser light source element 2a. Furthermore, in this example shown in FIG. 4(c), the laser light source element 2b that generates the second most heat (the smallest amount in this example) is disposed between the laser light source elements 2c and 2a that generate the most heat, which enhances the cooling efficiency by separating the laser light source elements 2c and 2a that generate larger amounts of heat. Alternatively, in this example, the positions of the laser light source elements 2c and 2a can be interchangeable.

As shown in FIG. 4(d), if the amount of heat generated by the laser light source elements 2a to 2c decreases in the order of G, R, and B (G>R>B), then the thickness of the support members 21a to 21c is made the same, while the width W3 of the support member 21a is made the largest, the width W1 of the support member 21c is made the next largest, and the width W2 of the support member 21b is made the smallest, so that the surface areas of the support members 21a to 21c are set so as to decrease in the order of the support member 21a, the support member 21c, and the support member 21b.

In this example shown in FIG. 4(d), the laser light source element 2a that generates the most heat out of the laser light source elements 2a to 2c is disposed at the end of the housing 11, which enhances the efficiency of heat release by the housing 11 for this laser light source element 2a, and the laser light source element 2c that generates the next most heat is disposed on the side where the volume of the housing 11 is larger, which enhances the efficiency of heat absorption and release by the housing 11 for this laser light source element 2c. Furthermore, in this example shown in FIG. 4(d), the laser light source element 2b that generates the least heat is disposed in between the laser light source element 2c that generates the second most heat and the laser light source element 2a that generates the most heat, which separates the laser light source elements 2a and 2c that generate larger amounts of heat, and improves cooling efficiency. As understood from the examples shown in FIGS. 4(b) and 4(d), the laser light source element that generates the most heat can be disposed either on the side where the volume of the housing 11 is larger or at the end of the housing 11. The cooling efficiencies at the side where the volume of the housing 11 is larger and the end of the housing 11 depend on the shape or structure of the housing 11. Thus, if the cooling efficiency at the side where the volume of the housing 11 is larger is larger than that at the end of the housing 11, then the arrangement shown in FIG. 4(b) can be employed. On the other hand, if the cooling efficiency at the side where the volume of the housing 11 is larger is smaller than that at the end of the housing 11, then the arrangement shown in FIG. 4(c) can be employed. Of course, the cooling efficiencies also depend on the configurations of the support members 21a to 21c. Thus, if the cooling efficiencies can be enhanced enough by the configurations of the support members 21a to 21c themselves, then the arrangement shown in FIG. 4(c) can also be employed even though the cooling efficiency at the side where the volume of the housing 11 is larger is larger than that at the end of the housing 11. Similarly, if the cooling efficiencies can be enhanced enough by the configurations of the support members 21a to 21c themselves, then the arrangement shown in FIG. 4(b) can also be employed even though the cooling efficiency at the side where the volume of the housing 11 is larger is smaller than that at the end of the housing 11. Basically, in the illustrated embodiment, the housing 11 shown in FIGS. 1 and 2 is configured such that the cooling efficiency at the side where the volume of the housing 11 is larger is larger than that at the end of the housing 11.

As is clear from the above examples, the surface areas of the support members 21a to 21c are set according to the amount of heat generated by the laser light source elements 2a to 2c that are supported, which allows effective cooling to be performed that corresponds to the amount of heat generated by the laser light source elements 2a to 2c. Furthermore, the laser light source elements 2a to 2c are disposed in the housing 11 according to the amounts of heat they generate, which allows effective cooling to be performed that corresponds to the amount of heat generated by the laser light source elements 2a to 2c.

In the illustrated embodiment, the plurality of laser light source elements 2a to 2c are disposed aligned in a single lateral row. However, the present invention is not limited to this layout, and various layouts can be employed, such as a mode in which some of the laser light source elements are disposed at a right angle to the other laser light source elements, or a mode in which some of the laser light source elements are disposed on the opposite side of the housing 11 from the other laser light source elements.

Also, in the illustrated embodiment, three laser light source elements 2a to 2c with mutually different color components are provided to the housing 11. However, the present invention is not limited to this, and various other modes can be employed, such as a mode in which two laser light source elements, or four or more, with the same or different color components are provided to the housing 11.

In the illustrated embodiment, a light source device has a plurality of laser light source elements that are attached to a housing via a plurality of support members, respectively. The surface areas of the plurality of support members are set according to the amount of heat generated by the laser light source elements they support.

Therefore, the amount of heat released via the support members increases in proportion to the amount of heat generated by the laser light source elements.

With this light source device, the support members all have the same thickness as the other support members, while the surface areas of these support members are adjusted so that the surface areas of the support members are different on the upper and lower faces. This reduces how much the laser light source elements stick out from the housing, and allows the light source device to be more compact.

With this light source device, the laser light source element that generates the most heat out of the plurality of laser light source elements is disposed at the end of the housing. This reduces the effect of heat generation from other laser light source elements, and allows heat from the laser light source element that generates the most heat to be dissipated more efficiently.

With this light source device, the laser light source element that generates the most heat out of the plurality of laser light source elements is disposed on the side of the housing with the larger volume. This allows heat from the laser light source element that generates the most heat to be transmitted through the support member to the housing, and affords more efficient cooling by utilizing the thermal capacity of the housing.

With this light source device, the laser light source element that generates the most heat out of the plurality of laser light source elements is disposed on the side of the housing with the larger surface area. This allows heat from the laser light source element that generates the most heat to be transmitted through the support member to the housing, and affords more efficient cooling by utilizing heat dissipation from the housing surface.

With this light source device, the laser light source element that generates the most heat out of the plurality of laser light source elements is disposed on the side where the housing structure is more complex. This allows heat from the laser light source element that generates the most heat to be transmitted through the support member to the housing, and affords more efficient cooling by utilizing heat dissipation from the housing surface and the thermal capacity of the housing.

This light source device can also be equipped with two or more laser light source elements. However, if there are three or more laser light source elements, such as those for a red component (R), a green component (G), and a blue component (B), then the laser light source element that generates the second largest amount of heat is disposed with another laser light source element interposed between it and the laser light source element that generates the most heat. This separates heat sources of relatively high temperature, and affords more efficient cooling overall.

In the illustrated embodiment, an image display device can include the above-mentioned light source device and display images by scanning with light emitted by laser light source elements. Here again, the heat dissipation via the support members, etc., is utilized to afford more efficient cooling of the laser light source elements.

With this image display device, the housing holds a scanning mirror for scanning with light emitted by the laser light source elements, and the laser light source element that generates the most heat out of the plurality of laser light source elements is disposed on the side of the housing where the scanning mirror is held. This allows heat transmitted to the housing to be dissipated by utilizing air convection produced by the pivoting drive of the scanning mirror, and affords more efficient cooling of the laser light source elements.

Various kinds of scanning mirror can be used. However, it is preferable to use a MEMS (Micro Electro Mechanical Systems) type of scanning mirror, which is advantageous in terms of compact size, lower power consumption, faster processing, and so on.

In the illustrated embodiment, a laser light source element can be cooled with a simple configuration.

### Second Embodiment

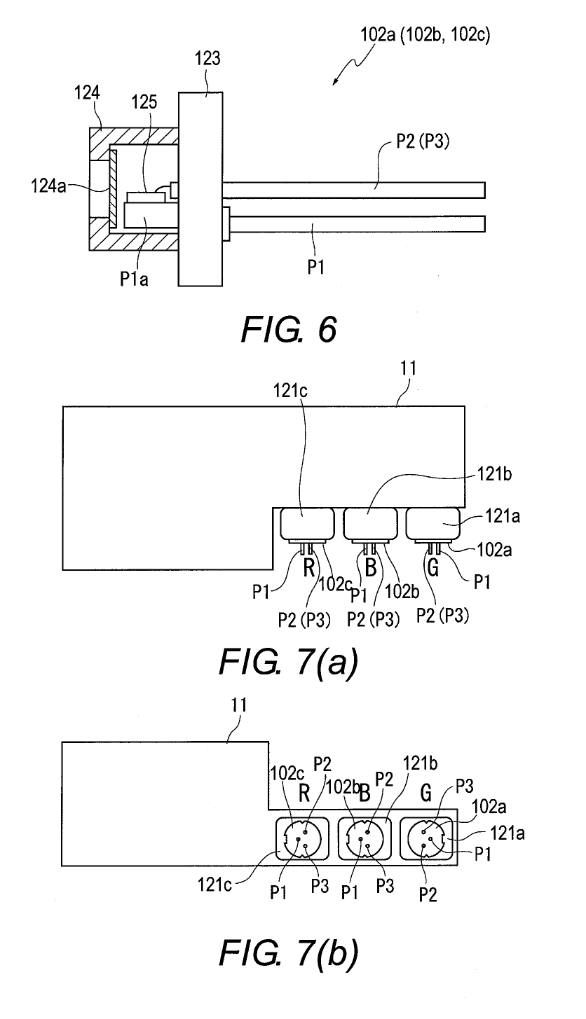

Referring now to FIGS. 6, 7(a), 7(b), and 8(a) to 8(e), a laser projector (e.g., an image display device) in accordance with a second embodiment will now be explained. In view of the similarity between the first and second embodiments, the parts of the second embodiment that are identical to the parts of the first embodiment will be given the same reference numerals as the parts of the first embodiment. Also, parts of this second embodiment that are functionally identical and/or substantially identical to parts of the first embodiment will be given the same reference numerals but with “100” added thereto. In any event, the descriptions of the parts of the second embodiment that are substantially identical to the parts of the first embodiment may be omitted for the sake of brevity. However, it will be apparent to those skilled in the art from this disclosure that the descriptions and illustrations of the first embodiment also apply to this second embodiment, except as discussed and/or illustrated herein.

The laser projector in accordance with the second embodiment is basically identical to the laser projector 1 illustrated in FIGS. 1 and 2, except for the layout or orientation of laser light source elements 102a to 102c. Thus, the detailed description of the laser projector in accordance with the second embodiment will be basically omitted for the sake of brevity. In the illustrated embodiment, the laser projector in accordance with the second embodiment includes the light source device 20 illustrated in FIG. 2. FIGS. 7(a) and 7(b) illustrate the layout of the laser light source elements 102a to 102c arranged in the housing 11.

In the illustrated embodiment, the laser light source elements 102a to 102c are provided to the housing 11, and are attached to the housing 11 via support members 121a to 121c, respectively.

These support members 121a to 121c are used to adjust the attachment position and orientation of the laser light source elements 102a to 102c, and to attach the laser light source elements 102a to 102c to the housing 11 at the designed position and orientation.

As shown in FIG. 2, the housing 11 holds the optical elements 3 to 8, the photodiode 9, and the MEMS scanning mirror 10. Because the scanning mirror 10 is housed, for example, the portion of the housing 11 on the downstream portion of the optical path has a shape in which the volume is larger than that of the upstream portion where the laser light source elements 102a to 102c are attached. Specifically, the portion of the housing 11 on the downstream portion of the optical path has a larger surface area than the upstream portion where the laser light source elements 102a to 102c are attached. Furthermore, since the scanning mirror 10 (e.g., a movable part) is housed, and the optical path for the scanning mirror 10 is set in the portion of the housing 11 on the downstream portion of the optical path, the housing itself is formed as having a complicated or intricate structure.

FIG. 6 is a partial cross sectional view of the laser light source elements 102a to 102c, illustrating the internal configuration. Of course, the laser light source elements 2a to 2c in accordance with the first embodiment can include the same configurations.

FIG. 6 illustrates the laser light source element 102a as a typical example, but the configuration of the other laser light source elements 102b and 102c is the same.

The laser light source element 102a has a substantially disk-shaped base plate 123, a cup-shaped cover 124 that is attached to the base plate 123, a light emitter 125 that is housed in the space formed by the base plate 123 and the cover 124, a support pin P1 that is attached so as to pass through the base plate 123 at a position offset from the center in order to support the light emitter 125, and power supply pins P2 and P3 that are attached so as to pass through the base plate 123 in order to supply drive current to the light emitter 125.

Thus, the support pin P1 of the laser light source element 102a protrudes at a position that is offset from the center of the laser light source element 102a.

The light emitter 125 in the illustrated embodiment is a semiconductor element that emits laser light of a specific wavelength according to the drive current. Drive current supplied from the laser driver 16 (see FIG. 1) is supplied to the light emitter 125 via the power supply pins P2 and P3 and wires connecting the power supply pins P2 and P3 with the semiconductor element. The light emitter 125 emits light according to the drive current, and the emitted laser light exits through a transparent window 124a in the cover 124.

The distal end of the support pin P1 serves as a base P1a, and the light emitter 125 is attached to this base P1a. The rear end of the support pin P1 protrudes from the base plate 123 to the outside of the laser light source element 102a, and heat generated by the light emitter 125 is transmitted from the base P1a to the support pin P1, and released from the rear end of the support pin P1 protruding to the outside.

In the illustrated embodiment, the base P1a is integrally formed with the support pin P1. However, the pin P1 can instead be formed to support the light emitter 25 by coupling the separately formed base P1a and support pin P1 as long as the light emitter 125 is connected to the support pin P1 through thermal conductivity. This pin P1 that supports the light emitter 25 is preferably formed from a material with high thermal conductivity, such as a metal with high thermal conductivity.

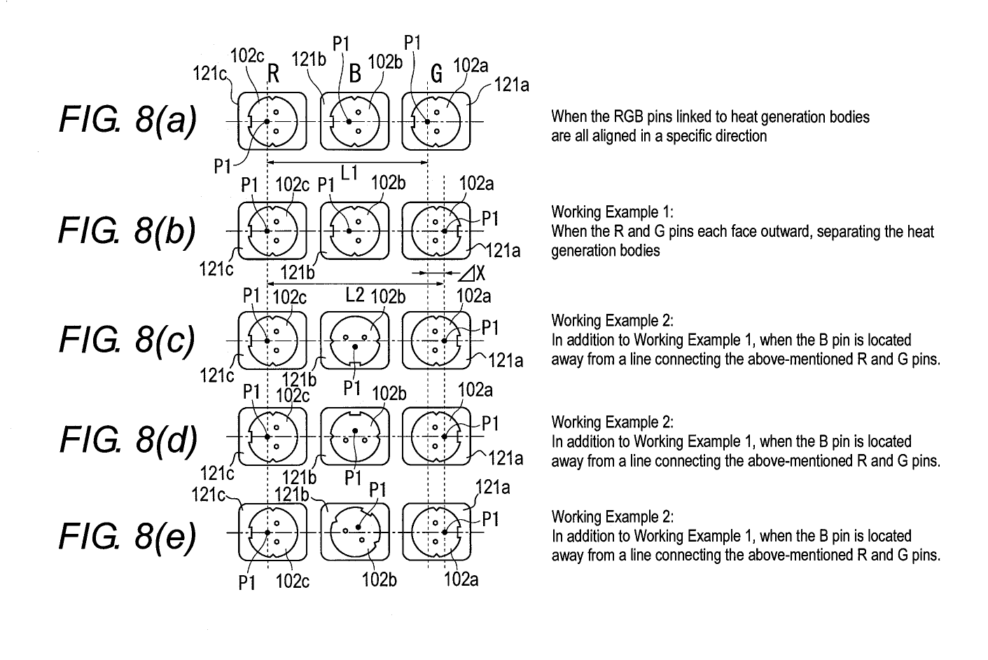

In the illustrated embodiment, as shown in FIGS. 8(a) to 5(e), to enhance the heat release effect from the rear end of the support pins P1 that protrude to the outside, the positional relation of the support pins P1 of the laser light source elements 102a to 102c is devised so that the laser light source elements 102a to 102c are disposed so as to separate the support pins P1 from each other as much as possible.

As shown in FIG. 8(a), if the support pins P1 of the G, B, and R laser light source elements 102a to 102c are disposed on a single, lateral straight line, then three support pins P1 are located within the interval L1 of the support pins P1 at both ends.

In this example, the laser light source element 102c disposed at the end (the left end in FIG. 8(a)) out of the laser light source elements 102a to 102c is attached to the housing 11 so that the support pin P1 is disposed more toward the end (the left end in FIG. 8(a)) than the center of the laser light source element 102c, so this support pin P1 is isolated from the other support pins.

On the other hand, as shown in FIG. 8(b), the laser light source element 102a disposed at the other end (the right end in FIG. 8(b)) out of the laser light source elements 102a to 102c is disposed so that it is rotated by 180 degrees compared to the orientation shown in FIG. 8(a), and is attached to the housing 11 so that its support pin P1 is disposed more toward this end (the right end in FIG. 8(b)) than the center of the laser light source element 102a, and so as to be isolated from the other support pins P1. Consequently, three support pins P1 are located within the interval L2, which is longer by ΔX than the above-mentioned interval L1, and heat from the light emitter 125 is released from the three support pins P1 in a state in which they have less effect on each other. An advantage to rotating the laser light source elements 102a by 180 degrees is that it maintains the major-minor axis relation of the laser beams emitted from the laser light source elements 102a to 102c, so there is no need to design the optical path to accommodate rotation of the laser beams.

Furthermore, as shown in FIGS. 8(c) to 8(e), the support pin P1 of the middle laser light source element 102b is disposed at a location that is spaced away from a straight line linking the support pins P1 of the two laser light source elements 102a and 102c at the ends, which further separates these three support pins P1 and allows heat to be released more effectively.

In this example, heat generated from the light emitter 125 is transmitted through the bases P1a, the support pins P1, and the base plates 123 to the support members 121a to 121c, and is then transmitted from the support members 121a to 121c to the housing 11. Therefore, heat generated by the laser light source elements 102a to 102c is absorbed or released by the support members 121a to 121c themselves, and heat is then absorbed or released by the housing 11, resulting in cooling.

The housing 11 and the support members 121a to 121c can be formed from a synthetic resin, a metal, or the like. However, it is preferable to use a material with high thermal conductivity.

The laser light source elements 102a to 102c each have different characteristics, design requirements for the laser projector 1, and so forth, and therefore the amount of heat generated by their operation also differs.

For instance, as shown in FIG. 5, if the laser light source element 102a outputs green (G) laser light with a wavelength of 515 nm, the laser light source element 102b outputs blue (B) laser light with a wavelength of 450 nm, and the laser light source element 102c outputs red (R) laser light with a wavelength of 638 nm, then the output of the laser light source elements (LD) needed for a white display of 1 lm decreases in the order of the R laser light source element 102c, the G laser light source element 102a, and the B laser light source element 102b (in order from largest to smallest), and the amount of heat generated due to this decreases in the same order.

Also, as shown in FIG. 5, for example, in the same situation, the LD threshold current decreases in the order of the G laser light source element 102a, the R laser light source element 102c, and the B laser light source element 102b, and the amount of heat generated due to this decreases in the same order.

Also, as shown in FIG. 5, for example, in the same situation, the order in which the conversion efficiency between the LD emission quantity and the power increases is the order of the G laser light source element 102a, the B laser light source element 102b, and the R laser light source element 102c (in order from smallest to largest), and the amount of heat generated due to this is in the same order.

The layout of the laser light source elements 102a to 102c and the layout of their support pins P1 are devised to accommodate the fact that the amount of heat generated by the laser light source elements 102a to 102c is thus different.

In FIGS. 8(a) to 8(e), the positional relation of the laser light source elements 102a to 102c to the housing 11 is the same as that in FIGS. 1, 2, 7(a) and 7(b), and the left side in the drawings is the side where the volume of the housing 11 is larger, and the side where the scanning mirror 10 is held.

On the other hand, in the example shown in FIGS. 8(b) to 8(e), if the amount of heat generated decreases in the order of the G laser light source element 102a, the R laser light source element 102c, and the B laser light source element 102b, then as shown in FIGS. 8(b) to 8(e), the laser light source element 102a, which generates the most heat out of the laser light source elements 102a to 102c, is disposed at the end of the housing 11, and the support pin P1 of this laser light source element 102a is also disposed at the end of the housing 11. Consequently, in addition to increasing the spacing between the support pins P1 as mentioned above, the laser light source element 102a that generates the most heat is disposed at the end of the housing 11, which enhances the efficiency of heat release by the housing 11 for that laser light source element 102a.

Furthermore, in this example, the laser light source element 102c that generates the second most heat is disposed with the other laser light source element 102b interposed between it and the laser light source element 102a that generates the most heat. Since the laser light source elements 102a and 102c that generate larger heat are separated, cooling efficiency is enhanced.

Alternatively, unlike in the above example, if the amount of heat generated decreases in the order of the R laser light source element 102c, the G laser light source element 102a, and the B laser light source element 102b, then as shown in FIGS. 8(b) to 8(e), the laser light source element 102c that generates the most heat out of the laser light source elements 102a to 102c is disposed on the side of the housing 11 where the volume is larger, and the support pin P1 of this laser light source element 102c is also disposed on the side of the housing 11 where the volume is larger. Consequently, in addition to separating the support pins P1 as mentioned above, the efficiency of heat absorption and heat release by the housing 11 for this laser light source element 102c is also enhanced.

Furthermore, in this example, the laser light source element 102a that generates the second most heat is disposed with the other laser light source element 102b interposed between it and the laser light source element 102c that generates the most heat. Since the laser light source elements 102a and 102c that generate larger heat are separated, cooling efficiency is enhanced. As mentioned above, the laser light source element that generates the most heat can be disposed either on the side where the volume of the housing 11 is larger or at the end of the housing 11. The cooling efficiencies at the side where the volume of the housing 11 is larger and the end of the housing 11 depend on the shape or structure of the housing 11. Thus, if the cooling efficiency at the side where the volume of the housing 11 is larger is larger than that at the end of the housing 11, then the laser light source element that generates the most heat can be arranged at the side where the volume of the housing 11 is larger. On the other hand, if the cooling efficiency at the side where the volume of the housing 11 is larger is smaller than that at the end of the housing 11, then the laser light source element that generates the most heat can be arranged at the end of the housing 11. Of course, the cooling efficiencies also depend on the configurations of the support members 121a to 121c. Thus, if the cooling efficiencies can be enhanced enough by the configurations of the support members 121a to 121c themselves, then the laser light source element that generates the most heat can be arranged at the end of the housing 11 even though the cooling efficiency at the side where the volume of the housing 11 is larger is larger than that at the end of the housing 11. Similarly, if the cooling efficiencies can be enhanced enough by the configurations of the support members 121a to 121c themselves, then the laser light source element that generates the most heat can be arranged at the side where the volume of the housing 11 is larger even though the cooling efficiency at the side where the volume of the housing 11 is larger is smaller than that at the end of the housing 11.

In the illustrated embodiment, a mode in which the laser light source element that generates the most heat is disposed on the side of the housing where the volume is the larger has the same meaning as a mode in which the laser light source element that generates the most heat is disposed on the side of the housing 11 with the larger surface area.

Also, a mode in which the laser light source element that generates the most heat is disposed on the side with the larger housing volume has the same meaning as a mode in which the laser light source element that generates the most heat is disposed on the side of the housing 11 where the scanning mirror 10 is housed, or is disposed on the side where the structure of the housing 11 is more complicated, since in this example the side with the larger volume in the housing 11 is formed by housing the scanning mirror 10, or the side with the larger volume in the housing 11 is formed by housing the optical path, optical elements, or the like.

As is clear from the above examples, when the laser light source elements 102a to 102c are disposed so as to separate their support pins P1 through which heat is directly transmitted from the light emitters 125, the laser light source elements 102a to 102c can be cooled more effectively. Furthermore, when the laser light source elements 102a to 102c and the support pins P1 are disposed in the housing 11 according to the amount of heat these generate, then more effective cooling will be possible that corresponds to the amount of heat generated by the laser light source elements 102a to 102c.

In the illustrated embodiment, the plurality of laser light source elements 102a to 102c are disposed aligned in a single lateral row. However, the present invention is not limited to this layout, and various layouts can be employed, such as a mode in which some of the laser light source elements are disposed at a right angle to the other laser light source elements, or a mode in which some of the laser light source elements are disposed on the opposite side of the housing 11 from the other laser light source elements.

Also, in the illustrated embodiment, three laser light source elements 102a to 102c with mutually different color components are provided to the housing 11. However, the present invention is not limited to this, and various other modes can be employed, such as a mode in which two laser light source elements, or four or more, with the same or different color components are provided to the housing 11.

In the illustrated embodiment, as illustrated in FIGS. 7(a) and 7(b), the support members 121a to 121c are identically formed with respect to each other. However, the support members 121a to 121c can be formed according to the amount of heat generated by the laser light source elements 102a to 102c as described in the first embodiment. For example, the support members 121a to 121c shown in FIG. 8(b) can be dimensioned in the same manner as the support members 21a to 21c shown in FIG. 4(b) (i.e., the surface areas of the support members 121a to 121c decreases in the order of the support member 121c, the support member 121a, and the support member 121b) when the amount of heat generated by the G, B and R laser light source elements 102a to 102c decreases in the order of R, G, and B (R>G>B). Similarly, the support members 121a to 121c shown in FIG. 8(b) can also be dimensioned in the same manner as the support members 21a to 21c shown in FIG. 4(c) when the amount of heat generated by the R and G laser light source elements 102c and 102a is substantially the same, and the amount of heat generated by the B laser light source element 102b is smaller than with these (R=G>B). Furthermore, the support members 121a to 121c shown in FIG. 8(b) can also be dimensioned in the same manner as the support members 21a to 21c shown in FIG. 4(d) when the amount of heat generated by the laser light source elements 102a to 102c decreases in the order of G, R, and B (G>R>B). Similarly, the support members 121a to 121c shown in FIGS. 8(c) to 8(e) can also be dimensioned in the same manner as the support members 21a to 21c shown in FIGS. 4(b) to 4(d), respectively.

In the illustrated embodiment, a light source device has a plurality of laser light source elements, in which the ends of pins that support light emitters protrude to the outside. The laser light source elements are attached to a housing. The laser light source elements disposed at the ends out of the plurality of laser light source elements are attached to the housing so that the pin is positioned more toward the end than the center of the laser light source elements.

Therefore, heat generated by the light emitters is transmitted to and released from the pins that protrude to the outside. Since the pins are separated from each other between the plurality of laser light source elements, heat is released from the pins more efficiently.

The light emitters here can be made of various materials according to the type of laser light source elements, and typically are semiconductor elements that emit laser light of a specific wavelength according to the drive current.

Various methods for disposing the pins separated from each other can be employed according to the number and layout relation of the laser light source elements, etc. For example, if there are three or more laser light source elements, these pins can be widely separated by disposing the other laser light source element so that the pin of the other laser light source element is located away from a straight line linking the pins of two of the laser light source elements.

Also, the method for disposing the pins separated from each other is preferably such that the laser light source element that generates the most heat out of the plurality of laser light source elements is disposed at the end of the housing, and the pin of the laser light source element is disposed on the end side of the housing. This reduces the effect of heat generated from the pins of the other laser light source elements, and allows heat from the laser light source element that generates the most heat to be efficiently released by the pin.

Also, the method for disposing the pins separated from each other is preferably such that the laser light source element that generates the most heat out of the plurality of laser light source elements is disposed on the side of the housing with the larger volume, and the pin of the laser light source element is disposed on the side of the housing with the larger volume. This allows heat from the laser light source element that generates the most heat to be transmitted through the pin to the housing, and affords more efficient cooling by utilizing the thermal capacity of the housing.

Also, the method for disposing the pins separated from each other is preferably such that the laser light source element that generates the most heat out of the plurality of laser light source elements is disposed on the side of the housing with the larger surface area, and the pin of the laser light source element is disposed on the side of the housing with the larger surface area. This allows heat from the laser light source element that generates the most heat to be transmitted through the pin to the housing, and affords more efficient cooling by utilizing heat release from the housing surface.

Also, the method for disposing the pins separated from each other is preferably such that the laser light source element that generates the most heat out of the plurality of laser light source elements is disposed on the side where the housing structure is more complex, and the pin of the laser light source element is disposed on the side where the housing structure is more complex. This allows heat from the laser light source element that generates the most heat to be transmitted through the pin to the housing, and affords more efficient cooling by utilizing heat release from the housing surface and its thermal capacity.

This light source device can also be equipped with two or more laser light source elements. However, if there are three or more laser light source elements, such as those for a red component (R), a green component (G), and a blue component (B), then the laser light source element that generates the second largest amount of heat is disposed with another laser light source element interposed between it and the laser light source element that generates the most heat. This separates heat sources of relatively high temperature, and affords more efficient cooling overall.

In the illustrated embodiment, an image display device can include the above-mentioned light source device and display images by scanning with light emitted by laser light source elements. Here again, the heat dissipation via the pins supporting the light emitters, etc., is utilized to afford more efficient cooling of the laser light source elements.

With the image display device, the housing holds a scanning mirror for scanning with light emitted by the laser light source elements, and the laser light source element that generates the most heat out of the plurality of laser light source elements is disposed on the side of the housing where the scanning mirror is held, and the pin of the laser light source element is disposed on the side of the housing where the scanning mirror is held. This allows heat transmitted to the housing to be dissipated by utilizing air convection produced by the pivoting drive of the scanning mirror, and affords more efficient cooling of the laser light source elements.

Various kinds of scanning mirror can be used. However, it is preferable to use a MEMS (Micro Electro Mechanical Systems) type of scanning mirror, which is advantageous in terms of compact size, lower power consumption, faster processing, and so on.

In the illustrated embodiment, a laser light source element can be cooled with a simple configuration.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image display device comprising:
a housing;
a plurality of support members attached to the housing; and
a plurality of light source elements attached to the housing via the support members, respectively,
the support members being dimensioned such that the support members have surface areas according to heat generation properties of the light source elements, respectively.

2. The image display device according to claim 1, wherein
the surface areas of the support members are different from each other while the support members have thicknesses that are equal to each other.

3. The image display device according to claim 1, wherein
a first one of the light source elements that has a largest heat generation property among the light source elements is disposed closer to an end portion of the housing than the other of the light source elements.

4. The image display device according to claim 1, wherein
the housing has first and second portions with the first portion having a larger volume than the second portion, and
one of the light source elements that has a largest heat generation property among the light source elements is disposed closer to the first portion than the other of the light source elements.

5. The image display device according to claim 1, wherein
the housing has first and second portions with the first portion having a larger surface area than the second portion, and
one of the light source elements that has a largest heat generation property among the light source elements is disposed closer to the first portion than the other of the light source elements.

6. The image display device according to claim 1, wherein
the housing has first and second portions with the first portion having a more complex structure than the second portion, and
one of the light source elements that has a largest heat generation property among the light source elements is disposed closer to the first portion than the other of the light source elements.

7. The image display device according to claim 3, wherein
a second one of the light source elements that has a second largest heat generation property among the light source elements is arranged relative to the first one of the light source elements such that a third one of the light source elements is disposed between the first one of the light source elements and the second one of the light source elements.

8. The image display device according to claim 1, further comprising
a scanning mirror configured to scan light emitted by the light source elements to display images.

9. The image display device according to claim 8, wherein
the scanning mirror is housed in a portion of the housing, and
one of the light source elements that has a largest heat generation property among the light source elements is disposed closer to the portion of the housing than the other of the light source elements.

10. The image display device according to claim 1, wherein
each of the light source elements includes a pin that extends outward of each of the light source elements, and a light emitter that is attached to an distal end portion of the pin, and
one of the light source elements that is disposed at an end among the light source elements is oriented such that the pin of the one of the light source elements is disposed away from the other of the light source elements with respect to a center of the one of the light source elements.

11. The image display device according to claim 10, wherein
the light source elements are oriented such that the pins of first and second ones of the light source elements define an imaginary line therebetween, and the pin of a third one of the light source elements are spaced away from the imaginary line.

12. The image display device according to claim 10, wherein
a first one of the light source elements that has a largest heat generation property among the light source elements is disposed closer to an end portion of the housing than the other of the light source elements, and
the pin of the first one of the light source element is disposed closer to the end portion of the housing than the center of the first one of the light source elements.

13. The image display device according to claim 10, wherein
the housing has first and second portions with the first portion having a larger volume than the second portion,
one of the light source elements that has a largest heat generation property among the light source elements is disposed closer to the first portion than the other of the light source elements, and
the pin of the one of the light source elements is disposed closer to the first portion than the center of the one of the light source elements.

14. The image display device according to claim 10, wherein
the housing has first and second portions with the first portion having a larger surface area than the second portion,
one of the light source elements that has a largest heat generation property among the light source elements is disposed closer to the first portion than the other of the light source elements, and
the pin of the one of the light source elements is disposed closer to the first portion than the center of the one of the light source elements.

15. The image display device according to claim 10, wherein
the housing has first and second portions with the first portion having a more complex structure than the second portion,
one of the light source elements that has a largest heat generation property among the light source elements is disposed closer to the first portion than the other of the light source elements, and
the pin of the one of the light source elements is disposed closer to the first portion than the center of the one of the light source elements.

16. The image display device according to claim 12, wherein
a second one of the light source elements that has a second largest heat generation property among the light source elements is arranged relative to the first one of the light source elements such that a third one of the light source elements is disposed between the first one of the light source elements and the second one of the light source elements.

17. The image display device according to claim 10, further comprising
a scanning mirror configured to scan light emitted by the light source elements to display images.

18. The image display device according to claim 17, wherein
the scanning mirror is housed in a portion of the housing,
one of the light source elements that has a largest heat generation property among the light source elements is disposed closer to the portion of the housing than the other of the light source elements, and
the pin of the one of the light source elements is disposed closer to the portion of the housing than the center of the one of the light source elements.
